(19) United States
(12) Patent Application Publication
(10) Pub. No.: US 2010/0046015 A1
(43) Pub. Date: Feb. 25, 2010

(54) METHODS AND SYSTEMS FOR CONTROLLED PRINTING OF DOCUMENTS INCLUDING SENSITIVE INFORMATION

(76) Inventors: Craig Thompson Whittle, Vancouver, WA (US); Gary Lin Gaebel, Vancouver, WA (US)

Correspondence Address: Duft Bornsen & Fishman, LLP, 1526 Spruce Street, Suite 302, Boulder, CO, 80302, US

(21) Appl. No.: 12/196,186

(22) Filed: Aug. 21, 2008

(51) Int. Cl. G06F 15/00

(52) U.S. Cl. 358/1.9

(57) ABSTRACT

Methods and systems for controllably printing documents including sensitive information. Features and aspects hereof provide a controller coupled to the marking engine. The controller applies rules to automatically detect the presence of sensitive information in a document to be printed and actions to securely print the document. Each rule includes a list of words and/or phrases deemed sensitive in the printing environment and actions to be taken when any of those words or phrases are detected. The actions may define, for example, that a user must enter authentication credentials at the marking engine to indicate that the user is physically present at the marking engine to receive the document printed. The rules may also specify, for example, that portions of the document detected as containing the sensitive information may be automatically modified/redacted by the controller prior printing the document.

### BACKGROUND

1. Field of the Invention

The invention relates generally to processing of print jobs including sensitive information. More specifically, the invention relates to methods and systems for improving security measures when printing documents including sensitive information.

2. Discussion of Related Art

Computer generated output may be directed through a printer driver in the computer system to printing devices as capable of imprinting the output on a printable medium. In a variety of such printing applications, sensitive information may be included in the computer generated output (e.g., “document”) to be printed. It is important in many such environments to assure that only the properly authorized users retrieve the printed output from the printing the device. Or, it may be important that if the document is printed, sensitive information must be modified or redacted. For example, documents including confidential information should be printed only when an authorized user is standing ready at the printing system to receive the confidential printed output. Examples of such confidential information may include secret information in classified document production environments, salary or other human resources information within a corporate environment, identification information such as Social Security numbers or other critical identification information, etc.

As presently practiced in the art, the user of the computer system generating the sensitive information is responsible for determining that the printing system should secure the printed output until the user is present at the printing system to receive the output. The user may, for example, indicate an option in the request for printing signifying a particular password or code to be entered at the printing system indicating that the user is standing ready to receive the sensitive printed information. Or, the user must manually consider what information is sensitive and then manually modify the document to redact such sensitive information before requesting that the document be printed. However, if the user simply forgets to set the appropriate option or fails to realize that sensitive information in the document should be secured, the printed output may be generated by the printing system without the authorized user being present to receive the printed output. Thus sensitive information may be retrieved by unauthorized personnel from the printing system before the authorized user is standing by ready to receive the printed output.

It is evident from the above discussion that a need exists for improved methods and systems for securing sensitive information in a document to be printed.

### SUMMARY OF THE INVENTION

The present invention solves the above and other problems, thereby advancing the state of the useful arts, by providing methods and systems for automating security for printing of documents including sensitive information. Features and aspects hereof include a capability to automatically parse or otherwise analyze a document to be printed and, responsive to detecting sensitive information in a document, modifying the content of the document and/or forcing the user to supply authentication credentials to be entered at the printing system indicating the authorized user is present to receive a sensitive printed material. The automatic recognition of sensitive information in a document to be printed may be performed within the user's computer system such as within an enhanced printer driver, or may be performed by a printer server network appliance, or by the printer itself through its printer controller. Recognition of sensitive information may comprise parsing the text in a document to be printed to recognize any of various defined sensitive keywords or phrases. Further, the recognition of sensitive information may also include optical character recognition (OCR) of a document image followed by parsing for sensitive information included within the converted text of imaged document.

In one aspect, a method is provided for securing the printing of documents including sensitive information. The method includes providing security policy rules for printing of documents including sensitive information and automatically detecting the presence of sensitive information in a document to be printed based on the rules. The method then prints the document, responsive to detecting the presence of sensitive information, according to the security policy rules to secure the sensitive information from unauthorized use.

In another aspect, a system is provided including a marking engine for imprinting information on a printable medium and a controller coupled to the marking engine for controlling the printing of documents including sensitive information on the marking engine. The system further includes a memory, coupled to the controller, storing security policy rules for printing of documents including sensitive information. The controller is adapted to automatically detect the presence of sensitive information in a document to be printed based on the rules. The controller is further adapted to print the document, responsive to detecting the presence of sensitive information, according to the security policy rules to secure the sensitive information from unauthorized use.

### BRIEF DESCRIPTION OF THE DRAWINGS

FIG. 1 is a block diagram of an exemplary system incorporating features and aspects hereof to print documents in a manner to secure sensitive information contained in the document.

FIGS. 2 through 4 are block diagrams showing exemplary physical embodiments of the controller of FIG. 1

FIGS. 5 through 7 are flowcharts describing exemplary methods in accordance with features and aspects hereof.

FIG. 8 is a block diagram of a controller adapted to process methods hereof embodied in a computer readable medium in accordance with features and aspects hereof.

### DETAILED DESCRIPTION OF THE DRAWINGS

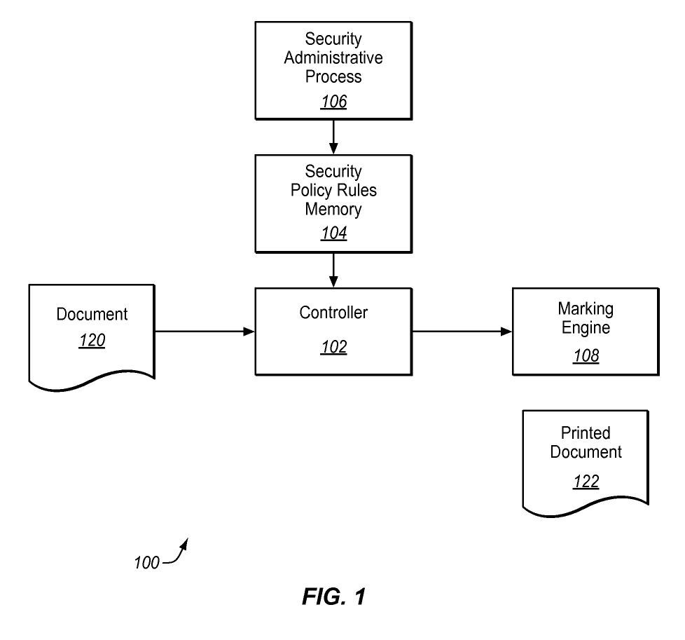

FIG. 1 is a block diagram showing an exemplary system 100 embodying features and aspects hereof providing for controlled printing of documents including the sensitive or secure information. Controller 102 of system 100 is coupled to a suitable memory 104 in which security policy rules are stored. Controller 102 receives a document 120 from any appropriate source such as a host system running an application program generating document 120. Controller 102 is adapted to process each of the rules specified in memory 104 to determine restrictions or modifications appropriate to printing document 120 if the application of the rule detects the presence of sensitive information in the document 120. Each rule in memory 104 may specify, for example, a list of words or phrases that may be deemed sensitive information and thus require that the document be printed with corresponding security actions. By way of example, a rule may specify that documents including numbers that appear to be social security numbers, bank account numbers, or other financial account numbers should be printed in a secure manner. Such a rule would then specify what actions should be taken by controller 102 to assure secure printing of the document in accordance with rules of the particular printing environment.

Controller 102 may modify the document 120 in accordance with specified security policy rules to redact or otherwise modify secure information within the document before printing. Further, by way of example, controller 102 may be instructed by appropriate security policy rules to require that a user provide an appropriate authentication code, such as a personal identification number or other password codes, to indicate that the user is physically present at the printing system to receive the printed document. Further exemplary rules are discussed herein below with respect to more detailed operation of controller 102.

After applying all applicable rules, controller 102 forwards the document (as modified by any applied rules) to the marking engine 108 for imprinting the document on the printable medium. Marking engine 108 thus produces printed document 122 in compliance with the security policy rules applied by controller 102. Where security policy rules applied by controller 102 specify that an authenticated user must be present to receive the sensitive information of the printed document 122, the printed document may then be retrieved by the authorized user physically present at the marking engine 108. Where the security policy rules applied by controller 102 modify or redact sensitive information in the document, printed document 122 will be presented with such modifications as to eliminate sensitive information detected by operations controller 102 based on the security policy rules 104. Additional details of the operation of system 100 are presented further herein below.

A security administrative process 106 may be operable in system 100 to provide a user interface for defining or modifying the security policy rules stored in memory 104. Thus an administrative user of system 100 may define appropriate rules suitable to the types of sensitive information that may appear in a particular printing enterprise application along with suitable actions to assure security of the matching sensitive information.

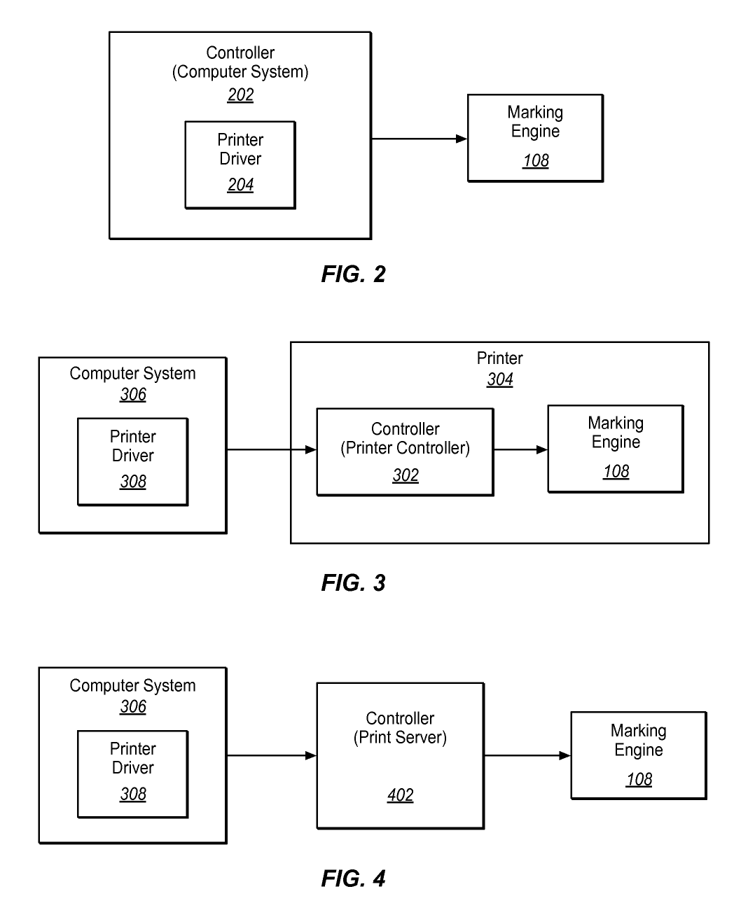

Controller 102 of FIG. 1 may be physically embodied in numerous configurations. FIG. 2 is a block diagram of one exemplary embodiment of a controller 202 as a computer system in which a printer driver 204 is operable to apply the security policy rules to received documents before transmitting the documents for printing to the marking engine 108. FIG. 3 presents another exemplary embodiment in which the controller is a printer controller 302 embedded within the printer 304 that also incorporates the marking engine 108. Printer 304 is coupled to a computer system 306 that incorporates a driver 308 operable to generate a document to be printed. The document to be printed is then transferred to printer 304 wherein the printer controller 302 applies the security policy rules to assure secure printing of sensitive information in the received document. FIG. 4 shows yet another exemplary embodiment where the controller is a print server 402 adapted to receive a document from computer system 306 generated by printer driver 308. The print server 402 then applies the security policy rules to the received document to assure secure printing of the document on marking engine 108 with regard to any sensitive information contained within the received document. Those of ordinary skill in the art will readily recognize numerous other physical embodiments of features and aspects hereof wherein a controller receives a document to be printed, applies security policy rules to detect whether sensitive information is present in the received document, and prints the received document in accordance with actions specified by the applicable security policy rules.

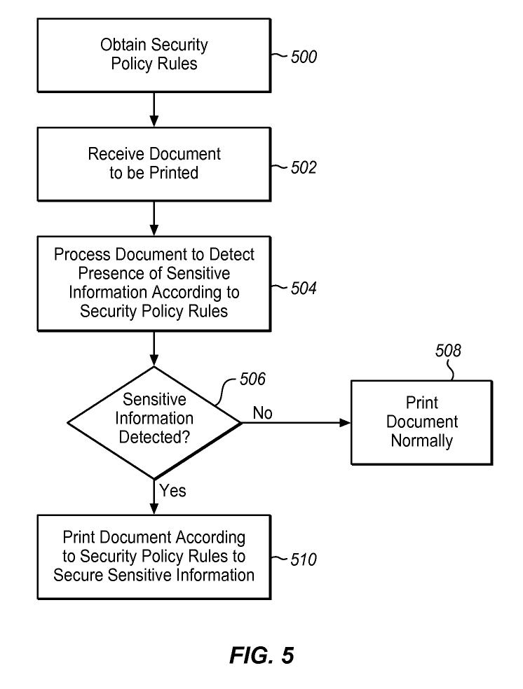

FIG. 5 is a flowchart describing a method in accordance with features and aspects hereof operable within a controller such as controller 102 of FIG. 1, controller 202 of FIG. 2, controller 302 of FIG. 3, and controller 402 of FIG. 4. Step 500 retrieves or otherwise receives the security policy rules from a memory associated with the controller operation. As discussed further herein below, an exemplary rule may specify a list of words and or phrases that are deemed to represent sensitive information. In addition, each rule may specify corresponding actions to be executed by the controller if any of the words and/or phrases in the list associated with a corresponding rule are found in the document. Details of exemplary actions are discussed further herein below but may include, for example, authentication of a user physically present at the marking engine to receive the printed document that includes sensitive information. Still other exemplary actions may include specified modifications to redact or otherwise modify secure information within the document prior to printing the document on the marking engine. Step 502 then receives a document to be printed from any appropriate source such as a host system driver or application, a spool file from a print server, etc. Step 504 next processes the document in accordance with the retrieved security policy rules to detect the presence of sensitive information in the received document. Step 506 then determines whether the processing of step 504 detected any sensitive information in the received document. If not, step 508 prints the document normally without any required security steps. For example, normal printing may simply involve transferring the received document to the marking engine without requiring any specific user authentication and without any modifications to the content of the document. Conversely, if step 506 determines that sensitive information was detected by the processing of step 504, step 510 prints the document according to the applicable security policy rules that successfully detected the sensitive information in the received document. Applying the security policy rules may include, for example, authentication of the user as physically present at the marking engine ready to receive the printed document with sensitive information. Additionally, application of the security policy rules may include modifying or redacting portions of the document prior to printing to remove sensitive information from the printed document. Additional exemplary details of processing the print document according to the security policy rules are provided herein below.

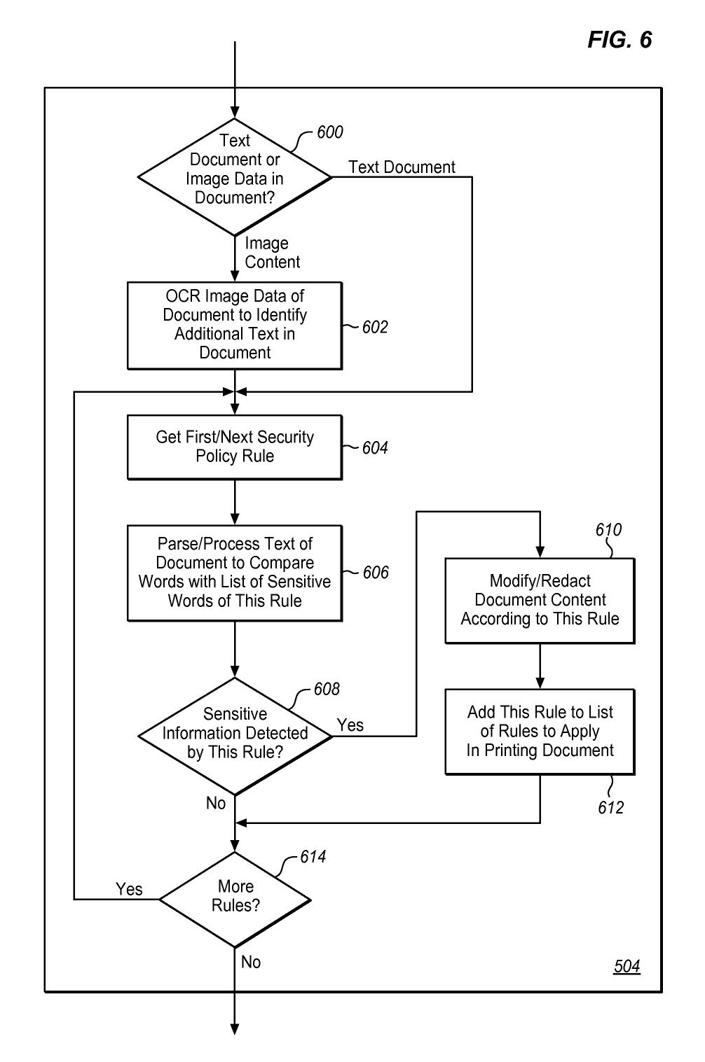

FIG. 6 is a flowchart describing exemplary additional details of the operation of step 504 of FIG. 5 to process a document in accordance with the security policy rules of the printing environment. Step 600 first determines whether the received document contains only text or some portion of image content. If the document contains only textual information, processing continues at step 604 as discussed below. If the received document contains at least some portion image content or other non-textual information, step 602 may apply optical character recognition (OCR) techniques to image data of the document to attempt to identify additional textual information in the received document. Any text detected by the OCR techniques may be logically appended to the document or in any other manner associated with the document for further processing as described herein below. Text so recognized by the OCR techniques is then processed as other textual information of the document in step 604.

Steps 604 through 614 are executed iteratively for each rule of the security policy rules provided in the printing environment. Step 604 starts processing with the first security rule. Step 606 then parses or otherwise processes the textual information of the received document (including any text detected in the document by OCR processing of step 602) to detect the presence of sensitive information in the text of the document. In general, each security policy rule includes an associated list of words or phrases that are deemed to represent sensitive information in this printing environment. Thus step 606 parses the text of the document comparing words and phrases in the document with the list of sensitive words applicable to the present security policy rule being processed. As noted above and as discussed further below, a user authentication process may be performed as part of a rule by comparing user entered credential information against parameters of the rule. For example, a rule may specify that particular words or phrases are sensitive for one user or class of users but are not sensitive for another user or another class of users.

Step 608 then determines whether the processing of step 606 detected any such sensitive information for the rule presently being processed. If not, step 614 determines whether more security policy rules remain to be processed. If so, the method loops back to step 604 to get the next security policy rule and continue processing until all security policy rules have been processed. Otherwise, processing of steps 504 is completed.

If step 608 determines that processing of step 606 detected the presence of sensitive information in accordance with this rule, step 610 next modifies or redacts the content of the document according to the actions of the rule. In general, each rule includes a list of one or more actions to be performed if the sensitive information in the corresponding list is detected as present in the document. Actions to be performed may include, for example, authentication of the user as physically present at that marking engine to receive the printed document containing sensitive information. Further, the actions may include, for example, defined modifications to the content of the document to redact or otherwise modify the sensitive information. Still further, for example, an action may specify that entire portions of the document that are detected as including sensitive information be removed when the document is printed. Specific modifications or redactions to the document content may be performed by step 610. Other actions that require input from the user to authenticate the user's presence at the printer may be performed later when the document is transferred to the marking engine. Thus, step 612 adds the present rule to a list of rules to be applied later when the document is printed on the marking engine. Processing then continues at step 614 as discussed above to determine whether additional rules remain to be checked. If so processing loops back to step 604. Otherwise processing of step 504 is complete.

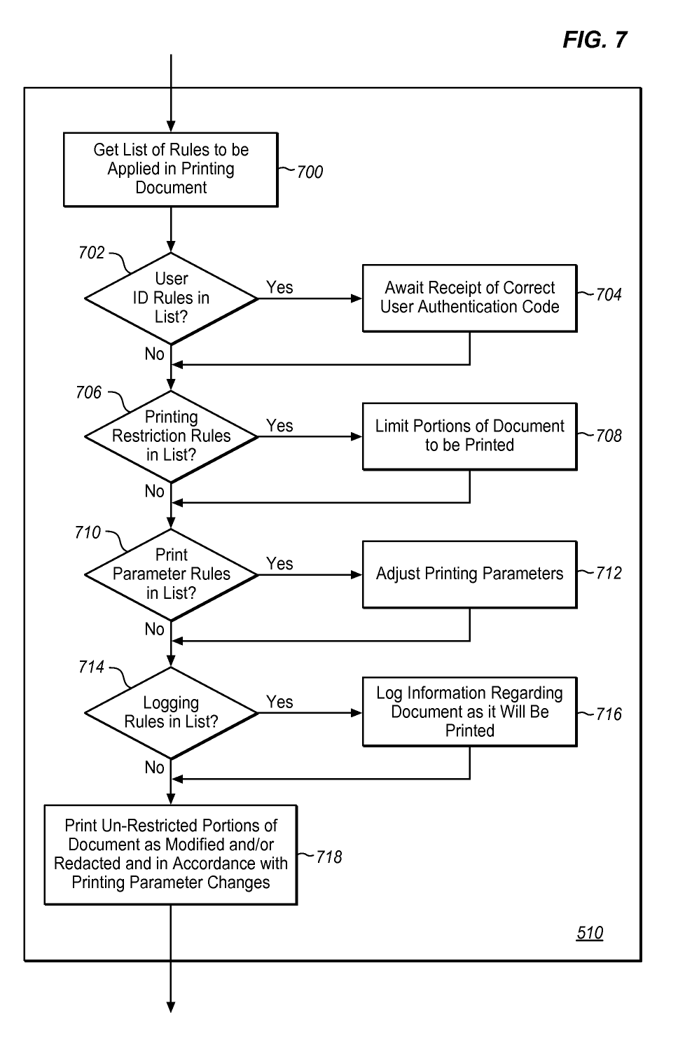

FIG. 7 is a flowchart describing exemplary additional details of the processing of step 510 of FIG. 5 to print the document (i.e., transfer the document to the marking engine) in accordance with the security policy rules added to the list of rules that detected sensitive information in the document. As noted above, some actions to be performed by a particular rule added to the list need to be performed at the time the document is transferred to the marking engine. Other rules may have previously modified the document content so as to redact sensitive information or otherwise modify the content of the document. Step 700 retrieves the list of rules to be applied in printing of the document as were previously saved in the processing of step 504 of FIGS. 5 and 6. Step 702 then determines whether the list of rules to be applied includes any rule requiring entry of a user authentication code to identify the user as an authorized user physically present at the marking engine to receive the printed document. If such rules are contained in the list of rules to be applied, step 704 performs the specified actions in the applicable rules to await receipt of a correct user authentication code indicating that the authorized user is physically present at the marking engine to receive the print a document. Any suitable user input device may be utilized in association with the marking engine to permit the user to enter an appropriate authentication code or password indicating that the user is physically present and ready to receive the document containing sensitive information. Processing then continues at step 706.

Step 706 next determines whether the list of rules to be applied at printing of the document includes any rules that restrict portions of the documents from being printed. For example, in conjunction with entry of a user authentication code, particular codes may indicate different levels of security to be applied for purposes of restricting what portions of the document may be printed. If so, step 708 then sets suitable indicia or variables to indicate portions of the document to be restricted from printing. Entire sequences of pages or portions of pages may be so limited or restricted from printing of the document on the marking engine. Processing then continues at step 710.

Step 710 then determines whether the list of rules to be applied in printing the document includes any rules that may modify parameters of the printing of the document. For example, a rule may specify an action that a particular document including sensitive information should be printed on certain printable medium or must be printed using certain colors or toners, etc. If so, step 712 adjusts printing parameters as specified by the actions of the applicable rules in the list of rules to be applied during printing. Processing then continues at step 714.

Step 714 then determines whether any actions are specified in the list of rules to be applied indicate that the printing of the document is to be logged. If so, step 716 logs appropriate information regarding the document as it will be printed. The log information may include, for example, the user authentication information indicating which user was identified as physically present at the printer at the time of printing to receive the document, which portions of the document were actually printed, which rules were applied to restrict the sensitive information in the printed document, etc. Such log information may be stored in a suitable memory within the controller or forwarded to an administrative process associated with the controller for suitable archiving. Processing then continues at step 718.

Lastly, step 718 prints the unrestricted portions of the document, as modified and/or redacted in accordance with the rules, and in accordance with any changes to the printing parameters. The document as so modified and/or redacted is then printed by the marking engine and thus presented to an authorized user.

Those of ordinary skill in the art will readily recognize numerous additional and equivalent steps that may be performed in the methods of FIGS. 5 through 7. Such additional and equivalent steps are omitted for simplicity and brevity of this discussion.

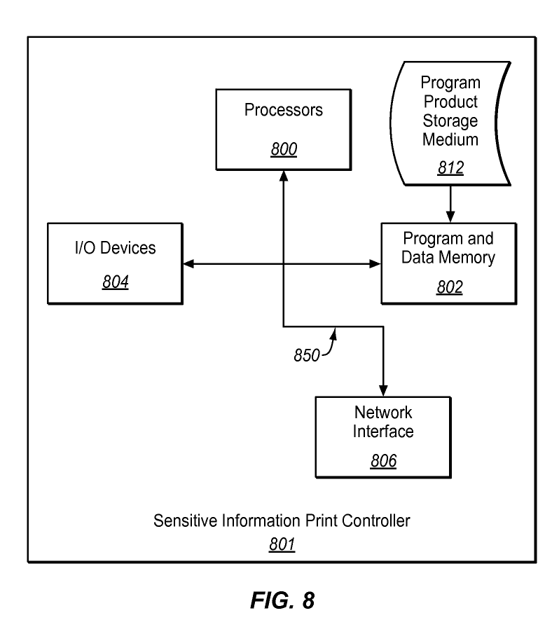

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc. FIG. 8 is a block diagram depicting a printing system 801 as a system adapted to provide features and aspects hereof by executing programmed instructions and accessing data stored on a computer readable storage medium 812.

Furthermore, the invention can take the form of a computer program product accessible from a computer-usable or computer-readable medium 812 providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor 800 coupled directly or indirectly to memory elements 802 through a system bus 850. As noted above, processors may be distributed among various control elements of a printing system such as in a rasterizing printer controller and a page extractor post-processing element. The memory elements can include local memory employed during actual execution of the program code, bulk storage, and cache memories which provide temporary storage of at least some program code in order to reduce the number of times code must be retrieved from bulk storage during execution.

Input/output or I/O devices 804 (including but not limited to keyboards, displays, pointing devices, etc.) can be coupled to the system either directly or through intervening I/O controllers. Network adapter interfaces 806 may also be coupled to the system to enable the data processing system to become coupled to other data processing systems or storage devices through intervening private or public networks. Modems, cable modems, IBM Channel attachments, SCSI, Fibre Channel, and Ethernet cards are just a few of the currently available types of network or host interface adapters.

While the invention has been illustrated and described in the drawings and foregoing description, such illustration and description is to be considered as exemplary and not restrictive in character. Various embodiments of the invention and minor variants thereof have been shown and described. In particular, those of ordinary skill in the art will readily recognize that exemplary methods discussed above may be implemented as suitably programmed instructions executed by a general or special purpose programmable processor or may be implemented as equivalent custom logic circuits including combinatorial and/or sequential logic elements. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method for securing the printing of documents including sensitive information, the method comprising:
providing security policy rules for printing of documents including sensitive information;
automatically detecting the presence of sensitive information in a document to be printed based on the rules; and
printing the document, responsive to detecting the presence of sensitive information, according to the security policy rules to secure the sensitive information from unauthorized use.

2. The method of claim 1
wherein the step of automatically detecting further comprises:
parsing text in the document to identify words included therein;
comparing the indentified words to a list of sensitive words; and
detecting the presence of sensitive information when any of the identified words is found in the list of sensitive words.

3. The method of claim 1
wherein the step of automatically detecting further comprises:
applying optical character recognition to image data included in the document to identify words included in the image data of the document;
comparing the indentified words to a list of sensitive words; and
detecting the presence of sensitive information when any of the identified words is found in the list of sensitive words.

4. The method of claim 1
wherein the security policy rules include requiring an authorized user to enter an authentication code before the document will be printed, and
wherein the step of printing further comprises:
awaiting receipt of the authentication code at the printer before commencing printing of the document.

5. The method of claim 4
wherein the security policy rules include associating a level of access indicia with each of multiple types of the sensitive information,
wherein the authentication code includes a level of access indicia and includes an associated password, and
wherein the step of printing further comprises:
varying the portions of the document to be printed based on the level of access indicia provided as input by the user.

6. The method of claim 1
wherein the security policy rules include automatically redacting portions of the document including sensitive information prior to printing the document.

7. The method of claim 1
wherein the security policy rules include logging printing of the document.

8. A system comprising:
a marking engine for imprinting information on a printable medium;
a controller coupled to the marking engine for controlling the printing of documents including sensitive information on the marking engine; and
a memory, coupled to the controller, storing security policy rules for printing of documents including sensitive information,
wherein the controller is adapted to automatically detect the presence of sensitive information in a document to be printed based on the rules, and
wherein the controller is adapted to print the document, responsive to detecting the presence of sensitive information, according to the security policy rules to secure the sensitive information from unauthorized use.

9. The system of claim 8
wherein the controller further comprises a printer driver operable in a computer system coupled to the marking engine.

10. The system of claim 8
wherein the controller further comprises a printer controller coupled to a computer system and coupled to the marking engine wherein the computer system generates the document to be printed.

11. The system of claim 8
wherein the controller further comprises a print server coupled to a computer system and coupled to the marking engine wherein the computer system generates the document to be printed.

12. The system of claim 8
wherein the security policy rules include requiring an authorized user to enter a authentication code before the document will be printed, and
wherein the controller is further adapted to await receipt of the authentication code at the printer before commencing printing of the document.

13. The system of claim 12
wherein the security policy rules include associating a level of access indicia with each of multiple types of the sensitive information,
wherein the authentication code includes a level of access indicia and includes an associated password, and
wherein the controller is further adapted to vary the portions of the document to be printed based on the level of access indicia provided as input by the user.

14. The system of claim 8
wherein the security policy rules include indicia of portions of the document including sensitive information to be redacted, and
wherein the controller is further adapted to redact the portions of the document to be printed prior to printing the document.

15. The system of claim 8
wherein the security policy rules include indicia that printing of the document should be logged, and
wherein the controller is further adapted to log the printing of the document.

16. A computer readable medium tangibly embodying programmed instructions which, when executed on a computer system, perform a method for securing the printing of documents including sensitive information, the method comprising:
providing security policy rules for printing of documents including sensitive information;
automatically detecting the presence of sensitive information in a document to be printed based on the rules; and
printing the document, responsive to detecting the presence of sensitive information, according to the security policy rules to secure the sensitive information from unauthorized use.

17. The medium of claim 16
wherein the step of automatically detecting further comprises:
parsing text in the document to identify words included therein;
comparing the indentified words to a list of sensitive words; and
detecting the presence of sensitive information when any of the identified words is found in the list of sensitive words.

18. The medium of claim 16
wherein the step of automatically detecting further comprises:
applying optical character recognition to image data included in the document to identify words included in the image data of the document;
comparing the indentified words to a list of sensitive words; and
detecting the presence of sensitive information when any of the identified words is found in the list of sensitive words.

19. The medium of claim 16
wherein the security policy rules include requiring an authorized user to enter an authentication code before the document will be printed, and
wherein the step of printing further comprises:
awaiting receipt of the authentication code at the printer before commencing printing of the document.

20. The medium of claim 19
wherein the security policy rules include associating a level of access indicia with each of multiple types of the sensitive information,
wherein the authentication code includes a level of access indicia and includes an associated password, and
wherein the step of printing further comprises:
varying the portions of the document to be printed based on the level of access indicia provided as input by the user.

21. The medium of claim 16
wherein the security policy rules include automatically redacting portions of the document including sensitive information prior to printing the document.

22. The medium of claim 16
wherein the security policy rules include logging printing of the document.
